(19) United States
(12) Patent Application Publication
(10) Pub. No.: US 2013/0197983 A1
(43) Pub. Date: Aug. 1, 2013

(54) Referral Networks

(71) Applicant: Sakthi A. Vel, Hockessin, DE (US)

(72) Inventor: Sakthi A. Vel, Hockessin, DE (US)

(21) Appl. No.: 13/360,677

(22) Filed: Jan. 28, 2012

(51) Int. Cl. G06Q 30/02

(52) U.S. Cl. 705/14.16

(57) ABSTRACT

A web based referral network system and method for tracking and rewarding multiple levels of referrers so that a seller can efficiently reach buyers for his products and service. This system is based on a system generated URL that tracks the deal ID and one or more referrers. Referrers disseminate this URL to their network through email or social networks. The system credits the referral amount to the referrers when the deal is purchased and the goods/services are acquired by the buyer. Also provided is a method and system for reducing the purchase price of the good/services in proportion to the number of entities referred by the referrer.

### FIELD OF THE INVENTION

The present invention relates to a method and system for tracking and rewarding multiple levels of referrers using the Internet, databases and servers so that sellers can efficiently reach buyers and sell their products/services.

### BACKGROUND OF THE INVENTION

Sellers reach buyers directly, through salespeople, one or more brokers, and/or referrers. One of the forms of compensation for these salespeople, brokers and referrers is a sales commission. At present, sellers are trying to leverage the social networks to induce individuals to refer their network to buy their products/services without financially compensating the referrers for their referrals. Multi-level marketing companies build a fixed top down structure and pay a commission to the individuals in the network based on the sales brought in by people down-line. It is unusual if not impossible for people in the lower strata to move up to people that are in the higher levels. The referral commissions are usually limited to one node. There is one salesperson or broker in between the buyer and seller. In real-estate sales, it is not uncommon to have more than one broker involved in a sale and the commissions are shared among the brokers in a pre-determined fashion. Also, in these deals, the prices of the goods/services are fixed and do not change whether the item is sold by the buyer in the first level or the fourth level.

Six degrees of separation refers to the idea that everyone is approximately six steps away, by way of introduction, from any other person on Earth. A chain of a friend of a friend can be made, on average, to connect any two people in six steps or fewer. The same concept can be applied to the concept that a buyer and seller are at most six steps away from each other with only five or less intermediaries. A referral system with 5 intermediaries should be able to connect any seller with any other buyer on Earth.

The advent of deal-sites in the past few years has taken the concept of coupon to the Internet where the deal-site acts as the broker and pockets the commission for a sale. The deal sites have a referral bonus for people who bring new deal-buying customers for the first time or whenever they buy a deal. Sometimes, when a customer buys a product and gets a three or more of his/her friends to buy, the referrer gets the product for free.

A review of a deal in a deal-site and a discussion on the differences is given below to show the difference between the current invention and the prior art. For example, a deal-site may sell an item of $100 value for $50. The buyer gains $50. The deal-site keeps $25 for its services and pays the merchant $25. The merchant loses $75 but makes a sale that he otherwise may not have made and hopes to gain the buyer as a repeat customer. The deal-site may have paid a referral fee, say $1, to someone else for referring this buyer either one-time or on a per sale basis. In one embodiment of the current invention, the deal-site will pay $10 out of its $25 share to any referrers who make a sale possible. This encourages the referrers to refer one or more of their friends who may be interested in the deal, even when the referrers do not purchase the deal. The reward is likely to promote sharing of a deal to the referrers' immediate circle of friends. The key difference is the referral reward is shared by the entire chain of referrers and not by just one person. This brings out the intimate knowledge of the referrers knowledge of their friends' needs, wants, and interests and pays them for making the sale possible in a targeted fashion. The deal-sites make the sale possible by making the offer irresistible (with discounts ranging up to 95% off in some cases) and several merchants have been an unhappy party in this deal. With a compensated referral chain, the deal is more likely to occur due to a buyer's need being met instead of being a purely great buy. This is likely to promote more commerce in a community with all three parties (seller, referrer(s) and buyers) being satisfied.

The concept of chain letters has been around for a long time. Email and social networks made it easy to distribute a chain letter. But the tracking mechanisms were not built in and they were usually filled with the horrible things that might happen if the letter was not forwarded to ‘n’ number of recipients or good things that might happen if it was forwarded to ‘n’ number of recipients. In either case there was no guarantor of either the good things or the bad things happening and no sure way to know. The current invention makes it very clear who offers the deal, the terms including clearly defined benefits not only to the buyer but also to the referrers in the chain.

### SUMMARY OF THE INVENTION

In accordance with the present invention, there is provided a method to track and pay a referral sales bonus to referrers ‘n’ levels deep, where n is equal to or greater than 1. The following parameters, among others, are tracked with an eye towards compensating the referrer for their knowledge and effort in providing the referrals; the number referred, the order of referral, the degrees of separation from the referred to the referrer and whether the referred make a purchase. Whenever a deal is purchased, all links upstream share in the referral sales bonus.

The system is deal based. The following activities, in addition to others, in the system with respect to deal are tracked: purchases of a deal, buyers and all referrals. These data are used to reward the referrers in the chain with their share of the referral sales bonus and to reduce the price of the goods/services to the referred based on the number of referrals down the line.

In accordance with the present invention, there is also provided a method to reduce the purchase price of the product/service to a referrer as the number of referrers in his/network increases.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a schematic view of the system of the present invention;

FIG. 2 is a block diagram for the system;

FIG. 3 is a list of the transactions recorded in the system when a purchase is made and when the voucher is redeemed for goods/services.

FIG. 4 is a flow chart for buyer registration;

FIG. 5 is a flow chart for seller registration;

FIG. 6 is a flow chart for charity registration; and

FIGS. 7-9, taken together is a flow chart for operations;

For purposes of clarity and brevity, like elements and components will bear the same designations and numbering throughout the Figures.

### DESCRIPTION OF THE PREFERRED EMBODIMENT

A glossary of terms is shown below.

Buyer: Individuals or organizations who are buying a product, service and offer through the system.

Seller: Individuals or organizations, who want to sell their goods/services to buyers.

Charities: Organizations or individuals who perform charitable work for the society. Charities register in the system and are approved by the system administrator 104. Once approved, buyers may select any one of them from the approved list to donate during checkout after they make a purchase.

Community: Buyers, Sellers, charities 102 and system administrators.

Buyer Referral Bonus: Through this system, Buyer A may refer an offer to Buyer B, through a URL (Uniform Resource Locator). The deal information and the referral details are encoded in this URL. When Buyer B buys this product/service by clicking on this link, and acquires the goods/services, Buyer A is credited a buyer referral bonus. This Buyer Referral bonus is determined by the Seller or by the System Administrator and is paid out of the purchase sale price of the goods/services. If Buyer B refers Buyer C and Buyer C buys the deal, and acquires the products/services, the referral bonus is split between Buyers B and A in a predetermined fashion.

Credit: Adding money to an account; when a buyer acquires goods/services, money is credited to the sellers account.

Debit: Subtraction of money from an account—for example, when a buyer buys a product, money is debited from his credit card account to the system's account.

Payment processor 100: An entity such as a bank's merchant account that processes credit card or ACH payments from payees and credits the funds to the recipient's bank accounts.

SIP: Session Initiation Protocol.

SIP provider 106: A provider who makes telephone calls possible through broadband Internet connections.

System Administrators: Employees or authorized personnel who maintain and control the system.

Transactions: The transfer of money (credits and debits) to various accounts in the system.

Deal: An offer from the seller that clearly outlines the goods/services being sold for a certain price. Other terms such as length of offer, time limit to buy, quantity available for purchase, referral sales bonus, among others, may be included in the deal.

Viral: The ability for the community to grow and spread in a viral fashion due to the referral bonus plan.

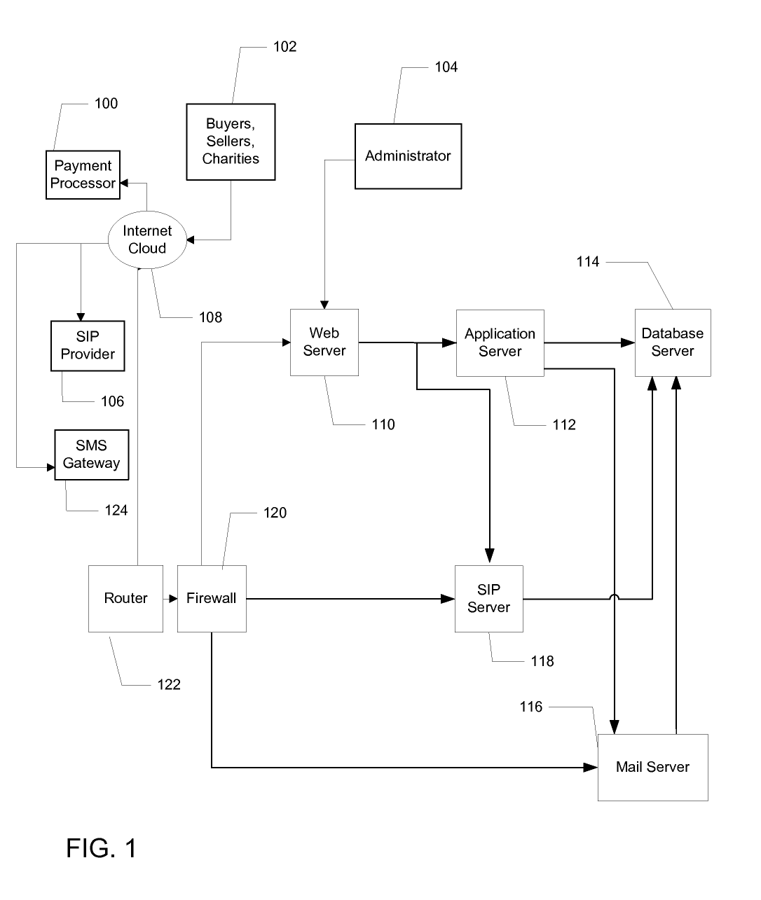

FIG. 1 is an example of a schematic diagram of architecture for the system in accordance with the present invention. The system consists of a router 122, firewall 120, web server 110, application server 112, database server 114, mail server 116, and SIP server 118. The web server is accessed by the buyers, sellers and charities through the Internet. The system administrator 104 accesses the admin site through the intranet. The system accesses the payment processor 100 and SIP provider 106 through the internet cloud 108. Payment processor 100 is used for any payments and refunds from payees to/from the system to the community. SIP provider 106 is used to initiate and complete telephone calls from a broadband connected computer (equipped with a microphone and speakers) through a web browser. The SIP server 118 is also used as an IVR (Interactive Voice Response) system herein.

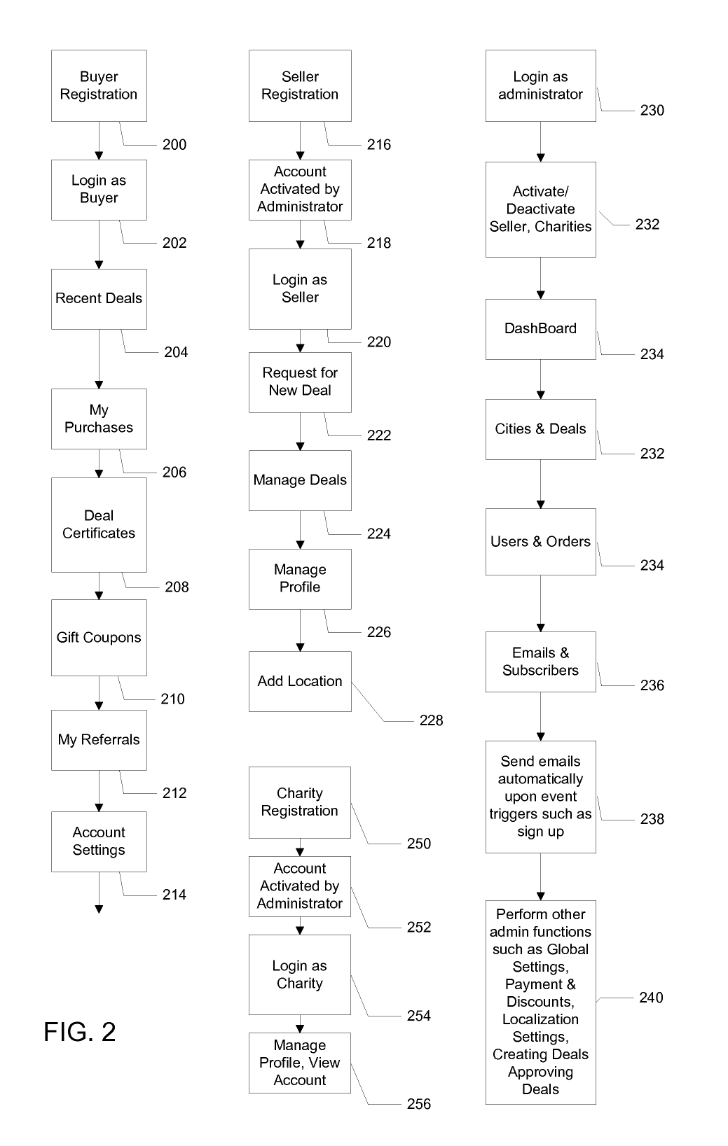

The system's community consists of buyers, sellers, charities 102 and the System Administrators. The system consists of two websites, an internet site and an intranet site. The buyers, sellers and charities access the system through the Internet and the System Administrators access the system through the intranet. The Internet site is available to be used by buyers, sellers and charitable organizations to register, login and conduct their activities in the system. The intranet site would be used by the system administrators to control the system and to perform administrative functions. A general overview of the activities conducted by each group of users is given in FIG. 2.

FIG. 2 is a block diagram of the system. In accordance with this invention Buyer registration 200 will be used to obtain details about the buyer during signup or registration. During the registration process or at a later time (after login as a buyer 202), the buyer may set buyer's profile and view one or more of the following: Recent Deals 204, My Purchases 206, Deal Certificates 208, Gift Coupons 210, My Referrals and Account Settings 214.

Sellers register themselves through the seller registration 216 module and charities register themselves through the charity registration 250 module in the internet website and provide information about their organizations and contact information. After registration and review, the seller account is activated by administrator 218. Similarly the charity account is activated by administrator 252. Once activated, sellers may conduct the various activities described in the column of boxes under seller registration 216. After logging in as a seller 220, the activities that a seller may conduct include, Request for a New Deal 222, Manage Deals 224, Manage Profile and Add Locations 228. Charitable organizations may also Manage Profile and View Accounts 256 and view charity reports 248 for their organizations after logging in as a charity 254.

After logging in as an administrator 230, the administrator 104 can perform several functions including: review registration information provided by sellers and charities and activate their accounts in the module and activate/deactivate sellers, charities 232, view Dashboard 234, manage Cities and Deals 232, manage Users and Orders 234, manage Emails and Subscribers 236, set triggers to send emails upon event occurrences such as signup 238. Administrators also perform other admin functions such as setting Global Settings, Make Payment, Setting Discounts, Localization Settings, Creating Deals and Approving Deals 240.

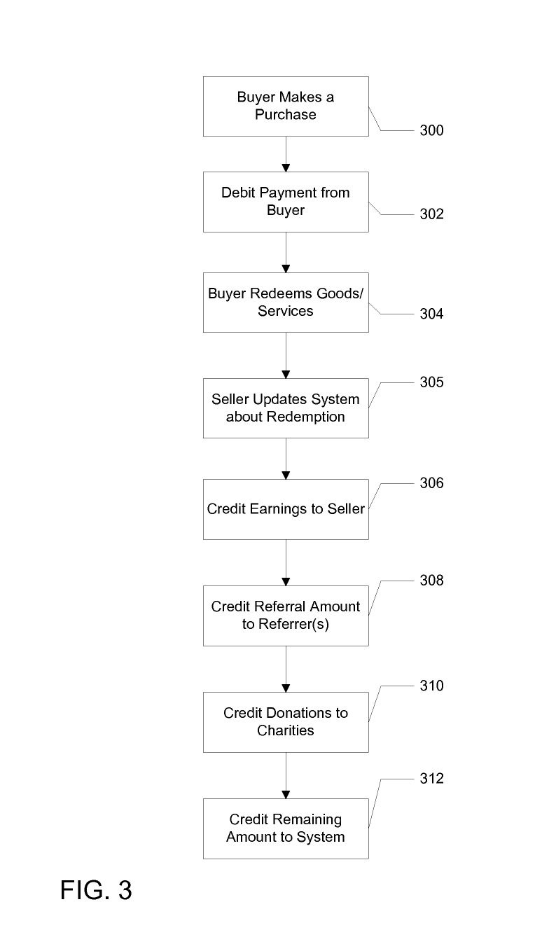

FIG. 3 is a list of credits and debits issued to the community when a Buyer makes a purchase 300. First, debit payment from buyer 302 is carried out. Once the buyer redeems Goods/Services 304, then the following credits are made to the appropriate accounts: credit earnings to seller 306, credit referral amounts to one or more referrers 308, credit donations to charities 310 and credit remaining amount to system 312.

Buyers, sellers and charities may signup in the system through the respective new-user registration pages in the public website.

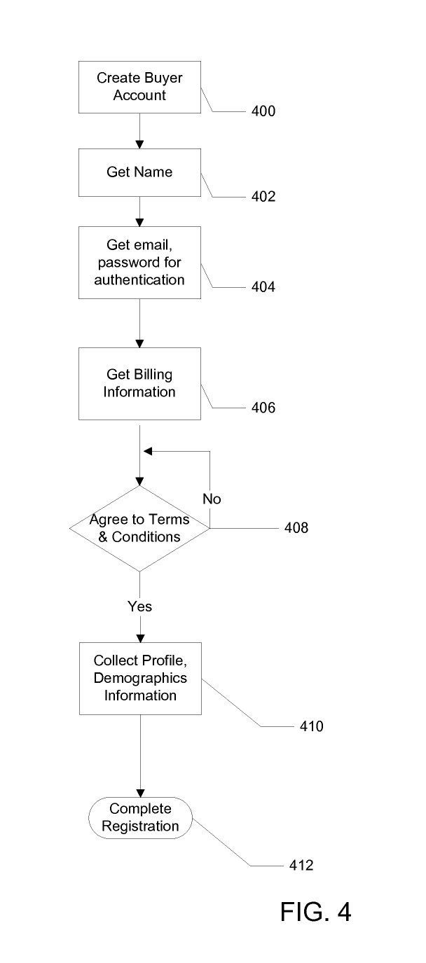

One possible embodiment of the buyer registration 200 is given in FIG. 4. Buyer can create a buyer account 400 with the system by responding to the get name 402, get email, password for authentication 404, get billing information 406. If the buyer agrees to terms and conditions 408, the system collects profile and demographics information 410. These steps complete the buyer registration process 412.

There are other details about the buyer that could be obtained in the signup process or during the update of this profile later. To expedite the signup process, only the most important parameters are collected. Other parameters such as gender, marital status, race, hobbies, education, occupation, industry, income and preferences may be non-mandatory and entered by the buyer after logging in to the site. This list of parameters is not exhaustive; other parameters that could help target buyer's needs and wants can be added as needed.

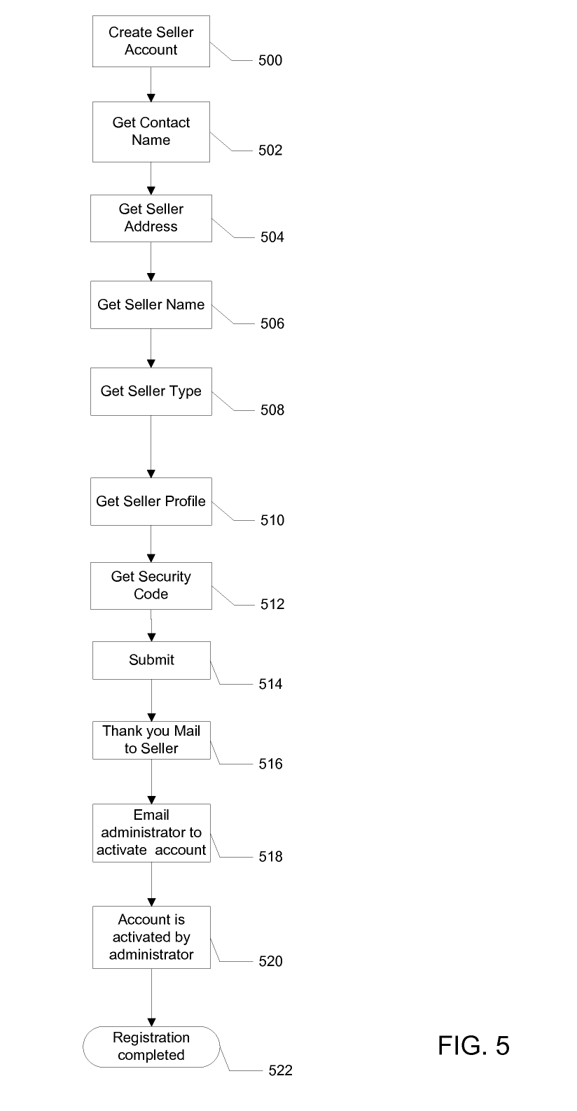

One possible embodiment of the seller registration 216 is given in FIG. 5. One can create a seller's account 500 from the seller's link in the public site by responding to the get contact name 502 and get seller address 504, get seller name 506, get seller type 508, get seller profile 510, and get security code 512. Upon clicking Submit 514, a thank-you email is generated to the seller 516 and an email to the administrator to activate the seller account 518 is generated as well. The account is activated by an administrator 520 and the seller registration process is completed 522.

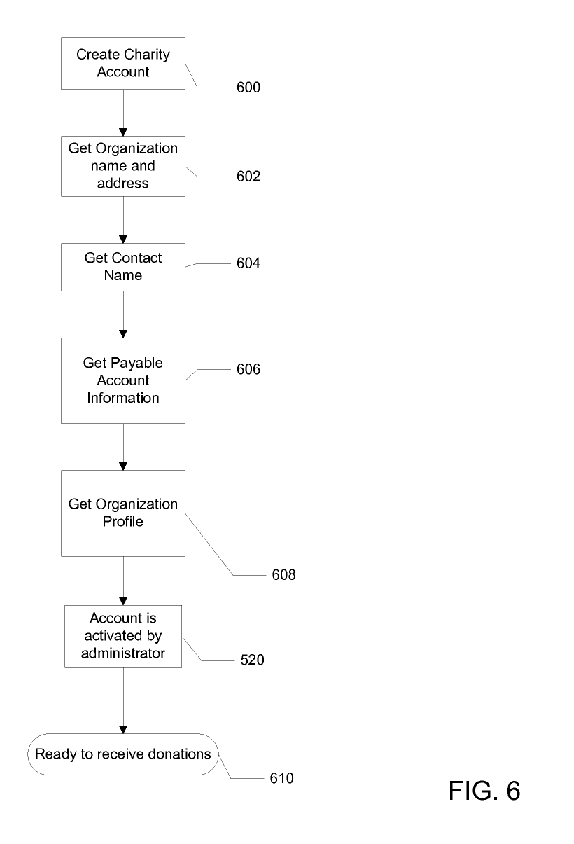

One possible embodiment of the registration by charitable organizations is given in FIG. 6. A user creates a charity account 600 from the ‘charities’ link in the public site by providing the organization name and address 602, contact name for charity 604 and get information for account-payable 606, get organization profile 608. The account is reviewed by the administrator prior to approval 520. The approved charity is now ready to receive donations 610.

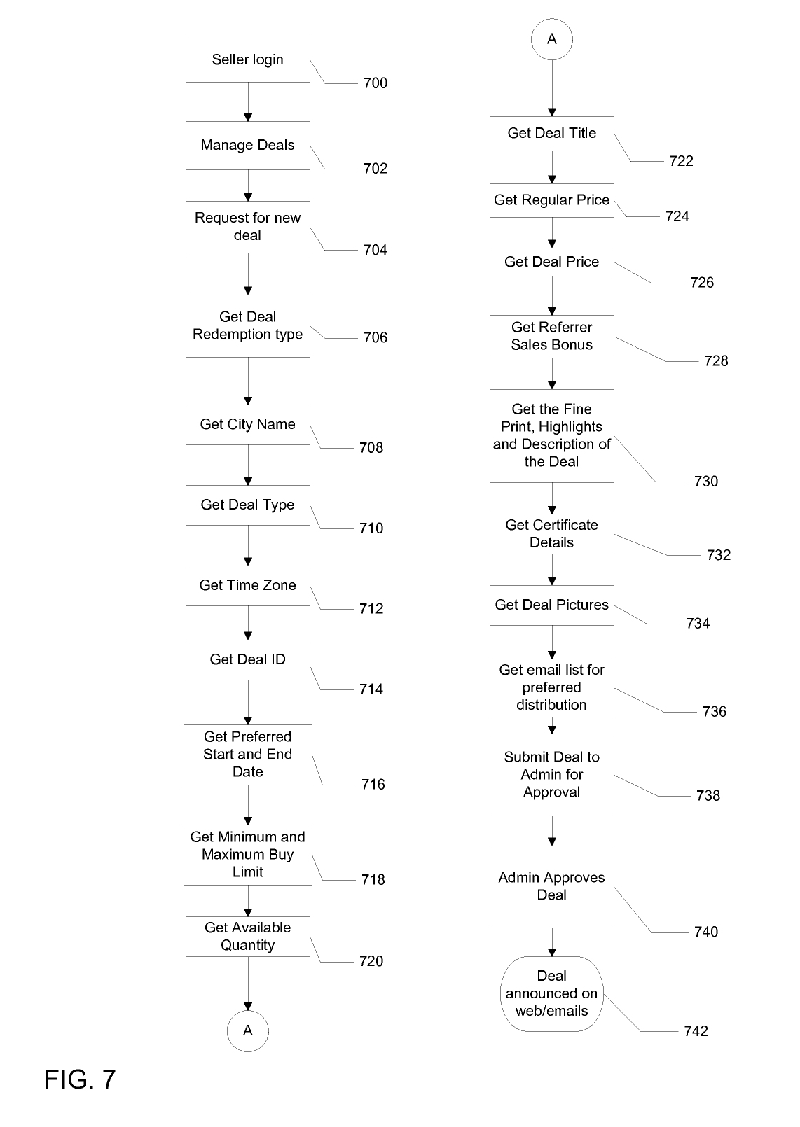

An embodiment in which a campaign is initiated by the seller to reach the buyer and the associated flow of funds through the system is given in FIGS. 7-9. In FIG. 7, a seller logs in 700, and chooses Manage Deals 702 and requests to create a new deal 704. The seller then enters deal parameters such as deal redemption type 706, city in which the deal will be available 708, deal type 710, time zone 712, deal ID 714, preferred start and end date 716, minimum and maximum quantities a buyer can buy 718 and the total available quantity 720 for sale. The seller also enters the following parameters: deal title 722, regular price 724, deal price 726, sales bonus or referrer sales bonus 728, fine print, highlights and description of the deal 730, deal certificate 732, and any pictures associated with the deal 734. The seller may also provide a list of email addresses 736 to which the deal URL would be preferably broadcast. These may be current customers who are likely to spread the word to others or one or more charities that may pass the deal on to members of as part of their fund-raising activities. By sending the deal URL to these preferred entities, the seller is giving them an early chance to share the deal and a chance to pocket the referral sales bonus. The seller then submits the deal to admin for approval 738. Once the admin approves the deal 740, the deal is published on the web and broadcast through emails 742.

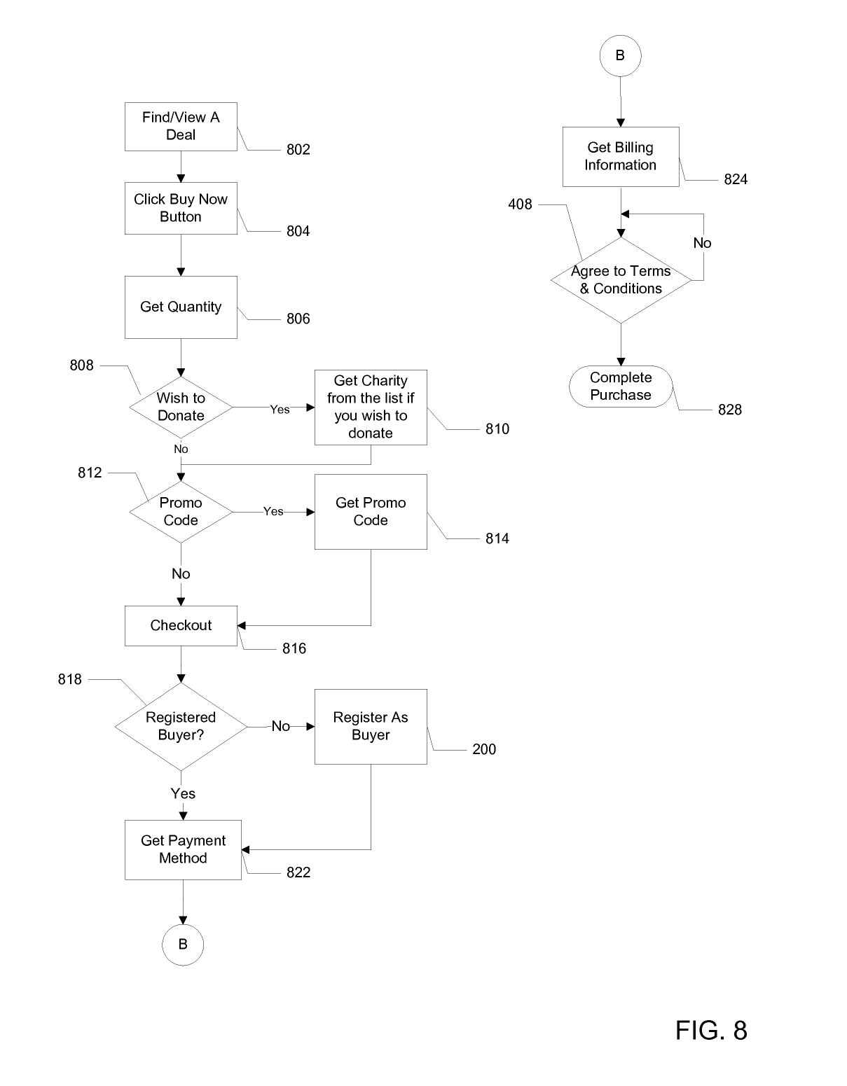

FIG. 8 shows an embodiment of how a deal may be purchased. A buyer finds the deal on the system website or views an email describing the deal 802. The buyer clicks the buy now button 804, and enters the quantity 806 that he wants to buy. He chooses whether he wants to donate 808 to a charity and selects from a list of registered charities 810. He then enters a promo code 812, if one is available 814 and then proceeds to checkout 816. If he is a registered buyer 818, he provides the payment method 822, billing information 824, agrees to terms and conditions 408 and completes purchase 828. If he is not a registered buyer 818, he registers as buyer 200, he provides the payment method 822, billing information 824, agrees to terms and conditions 408 and completes purchase 828.

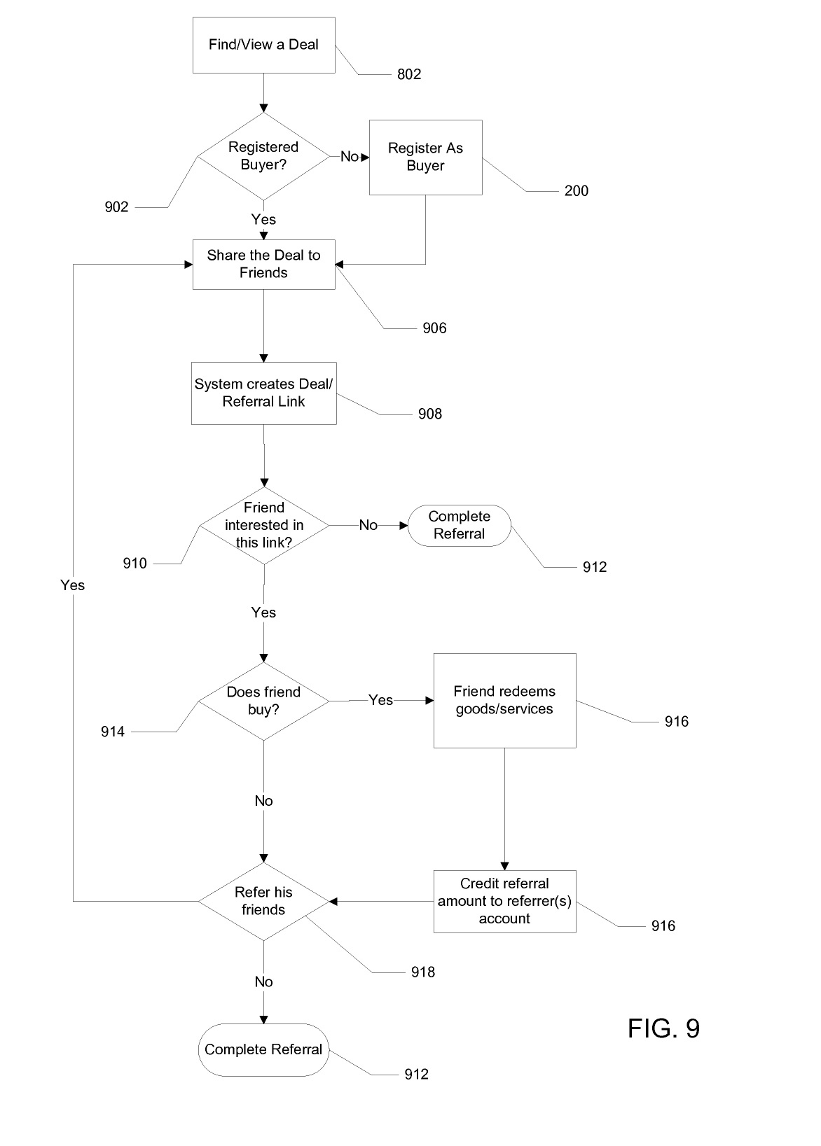

An embodiment of how a referral sales bonus is distributed to referrers when a purchase is made is shown in FIG. 9. A potential buyer A finds/views a deal 802. If he is not a registered buyer 902, he registers as a buyer 200. Then this buyer (also known as referrer A) shares the deal to one or more of his friends through email or social networks. The system creates a unique URL that codes in the deal ID 714 and the referrer A. When his friend (Buyer B) who is interested in the deal 910 buys the deal 914, a voucher is emailed to Buyer B and the system records that referrer A has the referral bonus available due to B buying the deal. When Buyer B redeems the voucher for goods/services 916, the system credits the referral sales bonus to Referrer A. Now Buyer B chooses to refer one or more of his friends, he becomes the second link in the chain. Let us denote Buyer B as referrer B for the next set of referrals. When a Buyer redeems a voucher for goods/services 916, the Seller can update 305 this transaction to the system through one of several means to mark the voucher as used including the following: access his account online or calling a phone number connected to the system through a IVR and entering the voucher. Is some instances, the buyer may present his voucher on a smartphone and the seller may simply click a button labeled “Mark as Used” to update the system and be eligible to be paid for completing the sale and redemption of goods/services.

Now this deal ID has two referrers, A and B. Let us say, B has referred C. C is interested in the deal 910, buys it 914 and redeems the voucher for goods/services 916. Now the referral sales bonus is split between A and B. In one embodiment, the bonus may be equally split between A and B. In another embodiment, one can envision that the bonus may be split in several possible ways with A or B getting a larger percentage. It is quite obvious that the bonus can be split in more ways than one. Now buyer C may refer one or more of his friends 918 (say for example D) and the cycle continues. In the next level, friend D may be interested in the deal simply for the purpose of passing it on and earning a referral bonus. It is not necessary for D to buy the product for the chain to continue. Since D does not buy the product, there is no referral sales bonus at this juncture. Now if D refers E and E purchases and redeems, all four referrers A, B C and D split the bonus. For the purposes of illustration, the referral bonuses earned by A, B C and D for the three purchases of this deal are shown below:

Referral Sales Bonus for a purchase—$60

Purchase by B: Referred by A—A gets referral bonus of $60
Purchase by C: Referred by A and B—A and B get referral bonus of $30, each
No purchase by D: Referred by A, B and C—A, B and C get referral bonus of $0
Purchase by E: Referred by A, B, C and D—A, B, C and D get a referral bonus of $15 each.
Whenever a referred person does not continue the referral chain, the referral process is completed.
In addition to the referral sales bonus, an additional reward that is envisioned is a reduction in the purchase price of the deal for each additional referral. This induces the referrer to spread the offer in the hope that this reduces his own purchase price even when none of the others in his network buy the offer. In one embodiment, a deal is set up so that every additional referral in the referral network reduces the purchase price by 10%. For example, ‘A’ originally gets the deal at a purchase price of $100 with an incentive that his purchase price drops by $5 for every referral that he brings in to view the offer. When A refers B and X, and B and X view the offer, A's purchase price for the deal goes down by $5 for each view to $90. If B refers C, the purchase price for A is reduced by another $5 to $90 and so on. In this scenario, purchase price for B will be $95 ($100-$ for referring C). The purchase price for X and C will be $100, since they have not yet referred anyone for this deal. The seller will set the floor price which is the lowest price that this product will be sold.
It is stated that there are at most six degrees of separation between any two humans on earth. In the preferred embodiment, it is envisioned that five links in the chain will be sufficient to connect a buyer anywhere in the world with a seller. It is quite obvious that the algorithm can be carried out for any number of links in the chain with a minimum of 1.
In addition to selling goods and services, the system can be used to promote and reward referrers wherever there is a buyer and a seller. Some of the situations include, but not limited to: employment relations where an employer seeks an employee or an employee seeks employment from an employer, matrimonial connections where a bride seeks a groom or a groom seeking a bride. This extends the current model of an employment agency serving as the hub between employers and employees to a multi-node network and improves the chances of employer and employee making a connection. The same argument applies to a groom seeking a bride as well.
The system can be used not only for selling goods and services but also for fund-raising by charities, politicians, political groups, Special Interest groups, among others. In one embodiment, charities can send out an email request for donations of $5, 10 and $25 for a particular cause to its patrons with a fund raising bonus of $1, $5 and $10, respectively, for anyone generating funds from their circle of friends for this cause.

In the embodiment discussed here, referral bonuses are paid out upon redemption. It is quite possible that there are scenarios where the payment can be made upon purchase of the voucher and not make the referrer(s) wait for redemption.

In the examples discussed here, the seller initiates the deal. It is quite possible that there are situations wherein the buyer can initiate the deal and offer to pay the referral bonus. Rare cases where the deals are originated both by the buyer and seller and intermediaries could make the connection and benefit from both offers.

The system can be extended to an auction through the referral network. For example, a charity could auction a training session with a sports legend. In one embodiment, the auction could be initiated with an original offer of $1,000 as the starting bid and 10% of the winning bid as referral sales bonus for the referrers and sent to a thousand of its patrons. The referral network can easily spread the offer to potential buyers who continue to bid the price higher. The auction ends at a pre-determined time or some other parameter to signal the winning bid. The links in the referral chain that led to the winning bid share the referral sales bonus.

In addition to the referral sales bonus, other enhancements can be envisioned to increase the excitement in the deal to create rapid dissemination of the deal; referrers who create the most number of nodes in their network, referrers who create the deepest network with the most number of levels, referrers who create a network of thousand or more in the shortest amount of time and referrers who create the widest geographical network or the most tightly focused network suited for hyper-local-marketing. A combination of any of these rewards with a limited quantity of goods/services being sold is likely to lead to a frenzy of activity in the network that brings a gaming excitement to the deal. A buyer has to weigh the cost of buying a product at the price that he is being offered now against waiting for some more time while his ever increasing network is lowering his purchase price for each additional member of the network.

A rapid spread of offers can be used to sell goods/services that have a rapidly expiring shelf-life. Some such good/services are tickets for concerts, cruises, planes and room rentals, among others.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A method for tracking and paying one or more referrers who make it possible for a seller to sell goods/services to a buyer using a networked computer system, comprising:
means for tracking and compensating all the referrers between the seller and buyer.

2. The method for tracking and paying one or more referrers in accordance with claim 1, wherein said means for tracking and compensating all the referrers between the seller and buyer comprises of a single URL that includes the key to identify the goods/services being sold, identify all the referrers and the order in which they referred one another.

3. A networked computer system for tracking and paying one or more referrers who make it possible for a seller to sell goods/services to a buyer through computers to buyers, comprising:
means for tracking and compensating all the referrers between the seller and buyer.

4. The system for tracking and paying one or more referrers in accordance with claim 3, wherein said means for tracking and compensating all the referrers between the seller and buyer comprises of a single URL that includes the key to identify the goods/services being sold, identify all the referrers and the order in which they referred one another.

5. A networked computer system for tracking a referral network, comprising:
means for reducing the deal purchase price for every additional person that the referrer and his network caused to view the deal.

6. The system for tracking a referral network in accordance with claim 5, wherein said means for reducing the purchase price comprises of a single URL that includes the key to identify the goods/services being sold, identify all the referrers and the order in which they referred one another.

7. A method for tracking a referral network using a networked computer, comprising:
means for reducing the deal purchase price for every additional person that the referrer and his network caused to view the deal.

8. The method for tracking a referral network in accordance with claim 7, wherein said means for reducing the purchase price comprises of a single URL that includes the key to identify the goods/services being sold, identify all the referrers and the order in which they referred one another.
